(19) United States
(12) Patent Application Publication
(10) Pub. No.: US 2026/0236352 A1
(43) Pub. Date: Aug. 13, 2026

(54) METHOD AND SYSTEM FOR RECOVERING ENDPOINT DEVICES

(71) Applicant: JPMorgan Chase Bank, N.A., New York, NY (US)

(72) Inventors: Jon MAEHLER, Westerville, OH (US); Michael WILDE, Newark, DE (US); Rocky MAUFORT, Delaware, OH (US); Paul MANALOTO, Woodridge, IL (US); Jeremy JOHNSTON, Lewis Center, OH (US); Jerome RULEWICZ, JR., Bear, DE (US)

(73) Assignee: JPMorgan Chase Bank, N.A., New York, NY (US)

(21) Appl. No.: 19/450,196

(22) Filed: Jan. 15, 2026

Related U.S. Application Data
(60) Provisional application No. 63/758,102, filed on Feb. 13, 2025.

(51) Int. Cl. G06F 11/14

(52) U.S. Cl. CPC G06F 11/1417

(57) ABSTRACT

A method and a system for performing endpoint device recovery are provided. The method includes: initiating a first boot cycle of an endpoint device; analyzing, during the first boot cycle, system components of the endpoint device to determine an operational state of the endpoint device; detecting, based on a result of the analyzing, a failure state of the endpoint device; initiating, a second boot cycle of the endpoint device from a network resource that includes a recovery control plane that is accessible by the endpoint device; and executing, via the recovery control plane, a repaving of the endpoint device to a workable state. The repaving includes utilizing at least one from among image management and version management.

### CROSS-REFERENCE TO RELATED APPLICATIONS

This application claims priority benefit from U.S. Provisional Application No. 63/758,102, filed on February 13, 2025, in the U.S. Patent and Trademark Office, which is hereby incorporated by reference in its entirety.

### Field of the Disclosure

This disclosure generally relates to methods and systems for performing endpoint device recovery, and more particularly to methods and systems for performing a series of processes to execute a touchless recoverability strategy to remedy endpoint devices so that they are in an operable state.

### Background Information

The CrowdStrike outage of July 2024 revealed vulnerabilities in elevated privilege design that is common among modern control agents. This outage exposed the fragility of common operating systems (e.g., Microsoft Windows Operating System (OS)) as an enterprise toolset for user endpoints. The core problem is that the common operating system is not self-healing or resilient to self-protect itself to guarantee its availability to users.

Traditional methods of preventing or recovering devices from incidents and outages suffer from a variety of problems. For example, upon a catastrophic failure at the device, current repave solutions can only be invoked by interaction at the physical device. Additionally, current solutions unilaterally decide when to apply a last known image to repave the device, which may not boot to a known good recovery image in certain conditions.

Moreover, traditional endpoint recovery systems do not have proactive monitoring or remediation at the sub-OS level to detect and/or respond to failure scenarios. Traditional endpoint recovery systems also rely on cloud orchestration that leverages above the OS control plane and does not help during catastrophic OS failure detection and/or response.

Additionally, traditional endpoint recovery systems rely on content delivery networks (CDN) that only allow for distribution of select files (e.g., OS Security Patches and Windows App store). Also, the ability to revert a change is currently dependent on the reverting of pushed policies or the invocation of a wipe and/or rebuild of the device.

Accordingly, there is a need for a system utilizing a touchless recoverability strategy for physical devices that incorporates physical assets, a cloud control plane recovery, and logic to provide a series of actions for recovering the device if it is determined to be in a bad state. Particularly, a method and system are needed for leveraging diverse solutions to minimize failure domain exposure, certify and secure hardware "system on chip" recovery capabilities to provide out-of-band control to non-recoverable endpoints, and incorporate a backup boot solution to steer to a known good recovery image under emergent conditions.

### SUMMARY

The present disclosure, through one or more of its various aspects, embodiments, and/or specific features or sub-components, provides, inter alia, various systems, servers, devices, methods, media, programs, and platforms for performing a series of processes to execute a touchless recoverability strategy to remedy endpoint devices so that they are in an operable state.

According to an aspect of the present disclosure, a method for performing endpoint device recovery is provided. The method may be implemented by at least one processor. The method may include: initiating, by the at least one processor, a first boot cycle of an endpoint device; analyzing, by the at least one processor during the first boot cycle, system components of the endpoint device to determine an operational state of the endpoint device; detecting, by the at least one processor and based on a result of the analyzing, a failure state of the endpoint device; initiating, by the at least one processor, a second boot cycle of the endpoint device from a network resource, wherein the network resource includes a recovery control plane that is accessible by the endpoint device; and executing, by the at least one processor via the recovery control plane, a repaving of the endpoint device to a workable state. The repaving may include utilizing at least one from among image management and version management.

The method may further include interacting, by the at least one processor via the recovery control plane, with a hardware component of the endpoint device to implement out-of-band control for incorporating the recovery control plane within the endpoint device to place the endpoint device in a recoverable state.

The analyzing of the system components may include performing a series of performance checks on at least one from among a hardware of the endpoint device, a hard drive of the endpoint device, and an operating system of the endpoint device to determine a source of error in the endpoint device.

The method may further include determining, by the at least one processor via the recovery control plane, whether an operating system of the endpoint device is in one from among an operable state, an inoperable state, and an override state.

The executing of the repaving may include implementing a first immutable image on the endpoint device. The first immutable image may include a software release and a patch release.

The first immutable image may be selected from an immutable image repository. The first immutable image may be a second most recent immutable image in the immutable image repository.

The method may further include transmitting, by the at least one processor via a telemetry system, the determined operational state of the endpoint device to a user.

The method may further include: storing, by the at least one processor in the recovery control plane, a result of the analyzing and a result of the detecting; comparing, by the at least one processor, the result of the analyzing and the result of the detecting with historical endpoint error data stored in the recovery control plane to determine a solution for remedying the failure state of the endpoint device.

According to another aspect of the present disclosure, a computing apparatus for performing endpoint device recovery is provided. The computing apparatus may include a processor; a memory; and a communication interface coupled to each of the processor, and the memory. The processor may be configured to: initiate a first boot cycle of an endpoint device; analyze, during the first boot cycle, system components of the endpoint device to determine an operational state of the endpoint device; detect, based on a result of the analyzing, a failure state of the endpoint device; initiate a second boot cycle of the endpoint device from a network resource, wherein the network resource includes a recovery control plane that is accessible by the endpoint device; and execute, via the recovery control plane, a repaving of the endpoint device to a workable state, wherein the repaving includes utilizing at least one from among image management and version management.

The processor may be further configured to interact, via the recovery control plane, with a hardware component of the endpoint device to implement out-of-band control for incorporating the recovery control plane within the endpoint device to place the endpoint device in a recoverable state.

The analyzing of the system components may include performing a series of performance checks on at least one from among a hardware of the endpoint device, a hard drive of the endpoint device, and an operating system of the endpoint device to determine a source of error in the endpoint device.

The processor may be further configured to determine, via the recovery control plane, whether an operating system of the endpoint device is in one from among an operable state, an inoperable state, and an override state.

The executing of the repaving may include implementing a first immutable image on the endpoint device. The first immutable image may include a software release and a patch release.

The first immutable image may be selected from an immutable image repository, and the first immutable image may be a second most recent immutable image in the immutable image repository.

The processor may be further configured to transmit, via a telemetry system, the determined operational state of the endpoint device to a user.

The processor may be further configured to: store, in the recovery control plane, a result of the analyzing and a result of the detecting; and compare the result of the analyzing and the result of the detecting with historical endpoint error data stored in the recovery control plane to determine a solution for remedying the failure state of the endpoint device.

According to yet another aspect of the present disclosure, a non-transitory computer readable storage medium storing instructions for performing endpoint device recovery is provided. The storage medium includes executable code which, when executed by a processor, may cause the processor to: initiate a first boot cycle of an endpoint device; analyze, during the first boot cycle, system components of the endpoint device to determine an operational state of the endpoint device; detect, based on a result of the analyzing, a failure state of the endpoint device; initiate a second boot cycle of the endpoint device from a network resource, wherein the network resource includes a recovery control plane that is accessible by the endpoint device; and execute, via the recovery control plane, a repaving of the endpoint device to a workable state. The repaving may include utilizing at least one from among image management and version management.

The executable code may further cause the processor to interact, via the recovery control plane, with a hardware component of the endpoint device to implement out-of-band control for incorporating the recovery control plane within the endpoint device to place the endpoint device in a recoverable state.

The analyzing of the system components includes performing a series of performance checks on at least one from among a hardware of the endpoint device, a hard drive of the endpoint device, and an operating system of the endpoint device to determine a source of error in the endpoint device.

The executable code may further cause the processor to determine, via the recovery control plane, whether an operating system of the endpoint device is in one from among an operable state, an inoperable state, and an override state.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for performing a series of processes to execute a touchless recoverability strategy to remedy endpoint devices so that they are in an operable state, according to an embodiment.

FIG. 2 illustrates a diagram of a network environment for performing a series of processes to execute a touchless recoverability strategy to remedy endpoint devices so that they are in an operable state, according to an embodiment.

FIG. 3 illustrates a system diagram of a system for performing a series of processes to execute a touchless recoverability strategy to remedy endpoint devices so that they are in an operable state, according to an embodiment.

FIG. 4 illustrates a process diagram of a process for performing a series of processes to execute a touchless recoverability strategy to remedy endpoint devices so that they are in an operable state, according to an embodiment.

FIG. 5 illustrates a flow diagram of a process for performing a series of processes to execute a touchless recoverability strategy to remedy endpoint devices so that they are in an operable state, according to an embodiment.

FIG. 6 illustrates a system diagram for performing a series of processes to execute a touchless recoverability strategy to remedy endpoint devices so that they are in an operable state, according to an embodiment, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units, and/or modules of the example embodiments may be physically combined into more complex blocks, units, and/or modules without departing from the scope of the present disclosure.

A system or method disclosed herein performs a series of operations for recovering endpoint devices (e.g., individual computers) from inoperable states. Particularly, the system performs a series of performance reviews on several components (e.g., hardware, hard drives, OS, etc.) of the endpoint device to determine a source of error within the endpoint device. When the system detects a failure state of the endpoint device, it initiates a second boot cycle, such that the endpoint device boots from a network resource that has a recovery control plane. The system then uses the recovery control plane to repave the endpoint device to a workable state. The system may also interact with the hardware of the endpoint device to implement out-of-band control for incorporating the recover control plane into the endpoint device to place the endpoint device in a recoverable state.

By utilizing several recovery mechanisms and strategies, the system is able to recover endpoint devices quickly and efficiently from incident outages that would normally leave the devices inoperable for extended periods of time. Particularly, the system leverages diverse solutions to minimize failure domain exposure. Additionally, the system certifies and secures hardware "system on chip" recovery capabilities to provide out-of-band control to non-recoverable endpoints. Moreover, the system recovery model may incorporate a backup boot solution to steer to a known good recovery image under emergent conditions and implement write-filter technology that will revert the operating system changes to a last known good state upon reboot.

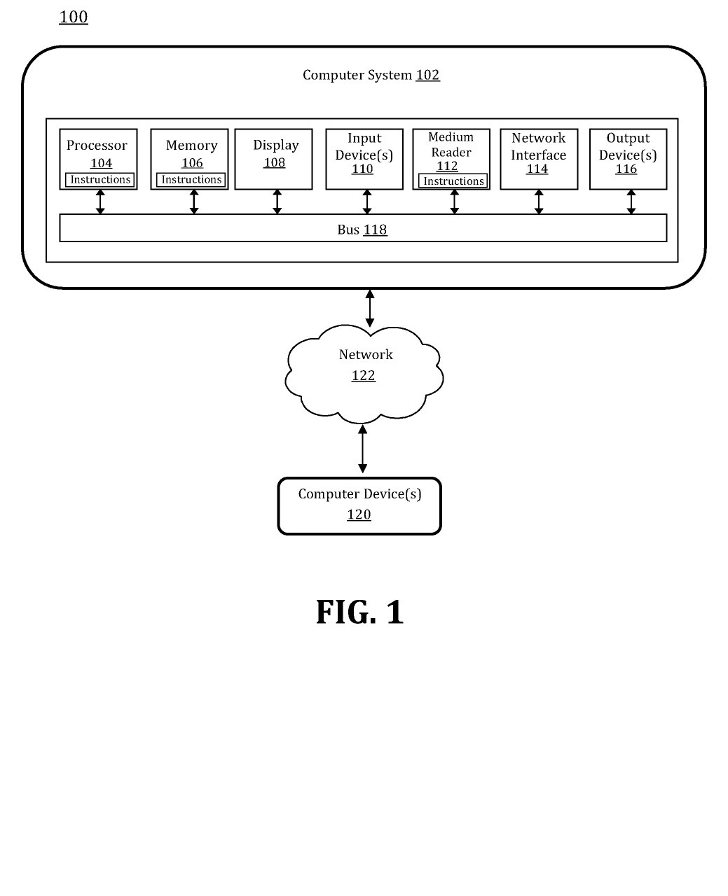

FIG. 1 is a system 100 for performing a series of processes to execute a touchless recoverability strategy to remedy endpoint devices so that they are in an operable state, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the endpoint recovery module implemented by the system 100 may allow for performing a series of processes to execute a touchless recoverability strategy to remedy endpoint devices so that they are in an operable state. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

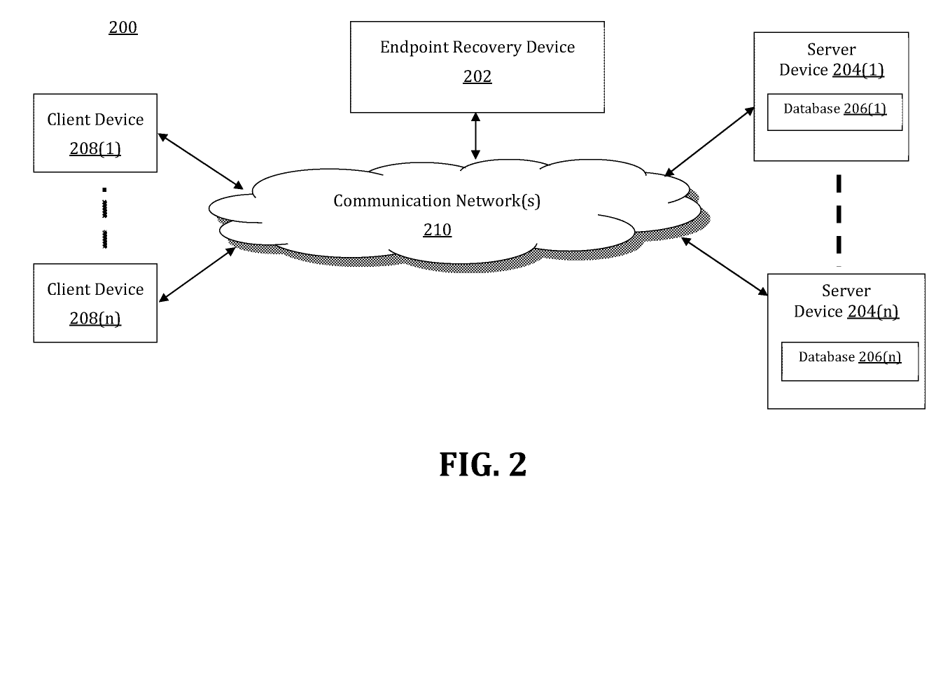

Referring to FIG. 2, a schematic of a network environment 200 for performing a series of processes to execute a touchless recoverability strategy to remedy endpoint devices so that they are in an operable state is illustrated.

In some embodiments, the above-described problems associated with conventional tools may be overcome by implementing an endpoint recovery device 202 as illustrated in FIG. 2 that may be configured for performing a series of processes to execute a touchless recoverability strategy to remedy endpoint devices so that they are in an operable state, but the disclosure is not limited thereto.

The endpoint recovery device 202 may include one or more computer systems 102, as described with respect to FIG. 1, which in aggregate provide the necessary functions.

The endpoint recovery device 202 may store one or more applications that can include executable instructions that, when executed by the endpoint recovery device 202, cause the endpoint recovery device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the endpoint recovery device 202 itself, may be located in virtual server(s) running in a cloud-based computing environment rather than being tied to one or more specific physical network computing devices. Also, the application(s) may be running in one or more virtual machines (VMs) executing on the endpoint recovery device 202. Additionally, in one or more embodiments of this technology, virtual machine(s) running on the endpoint recovery device 202 may be managed or supervised by a hypervisor.

In the network environment 200 of FIG. 2, the endpoint recovery device 202 may be coupled to a plurality of server devices 204(1)-204(n) that hosts a plurality of databases 206(1)-206(n), and also to a plurality of client devices 208(1)-208(n) via communication network(s) 210. A communication interface of the endpoint recovery device 202, such as the network interface 114 of the computer system 102 of FIG. 1, operatively couples and communicates between the endpoint recovery device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the endpoint recovery device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The endpoint recovery device 202 may be a standalone device or integrated with one or more other devices or apparatuses, such as one or more of the server devices 204(1)-204(n), for example. In one example, the endpoint recovery device 202 may be hosted by one of the server devices 204(1)-204(n), and other arrangements are also possible. Moreover, one or more of the devices of the endpoint recovery device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the endpoint recovery device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the endpoint recovery device 202 that may perform a series of processes to execute a touchless recoverability strategy to remedy endpoint devices so that they are in an operable state, but the disclosure is not limited thereto.

The client devices 208(1)-208(n) may run interface applications, such as standard web browsers or standalone client applications, which may provide an interface to communicate with the endpoint recovery device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the endpoint recovery device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the endpoint recovery device 202, the server devices 204(1)-204(n), or the client devices 208(1)-208(n), for example, may be configured to operate as virtual instances on the same physical machine. For example, one or more of the endpoint recovery devices 202, the server devices 204(1)-204(n), or the client devices 208(1)-208(n) may operate on the same physical device rather than as separate devices communicating through communication network(s) 210. Additionally, there may be more or fewer endpoint recovery devices 202, server devices 204(1)-204(n), or client devices 208(1)-208(n) than illustrated in FIG. 2. In some embodiments, the endpoint recovery device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

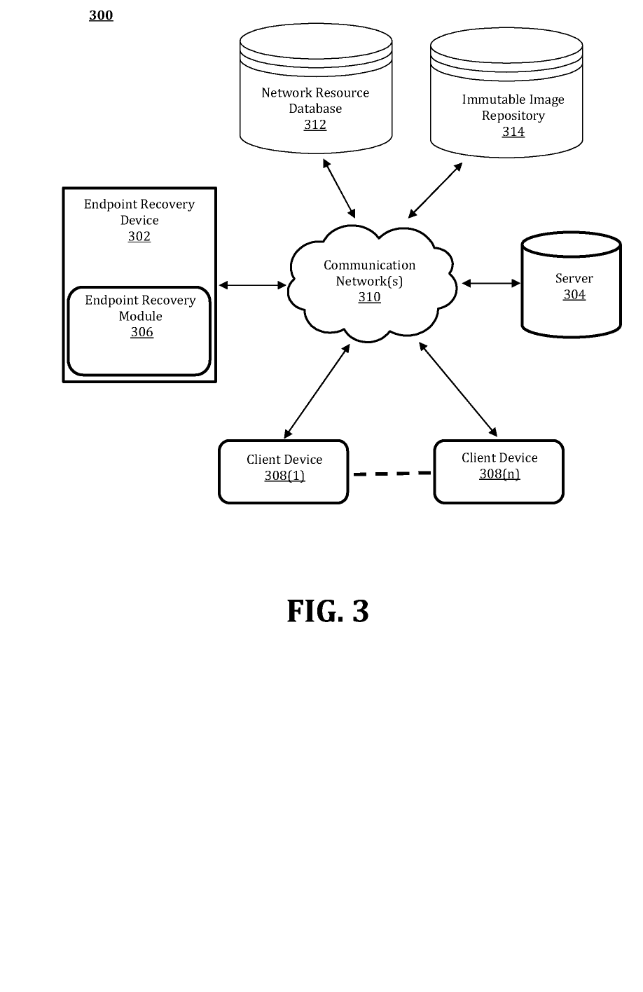

FIG. 3 illustrates a system diagram for performing a series of processes to execute a touchless recoverability strategy to remedy endpoint devices so that they are in an operable state, in accordance with an embodiment.

As illustrated in FIG. 3, the system 300 may include an endpoint recovery device 302 within which an endpoint recovery module 306 is embedded, a server 304, a network resource database 312, an immutable image repository 314, a plurality of client devices 308(1) … 308(n), and a communication network 310.

In some embodiments, the endpoint recovery device 302 including the endpoint recovery module 306 may be connected to the server 304, the network resource database 312, and the immutable image repository 314 via the communication network 310. The endpoint recovery device 302 may also be connected to the plurality of client devices 308(1) … 308(n) via the communication network 310, but the disclosure is not limited thereto. The network resource database 312 and the immutable image repository 314 may include one or more repositories or databases.

In an embodiment, the endpoint recovery device 302 is described and shown in FIG. 3 as including the endpoint recovery module 306, although it may include other rules, policies, modules, databases, or applications, for example. In some embodiments, the network resource database 312 and the immutable image repository 314 may be configured to store ready to use modules written for each API for all environments. Although only one database is illustrated in FIG. 3, the disclosure is not limited thereto. Any number of desired databases and/or repositories may be utilized for use in the disclosed invention herein. Each of the network resource database 312 and the immutable image repository 314 may be a mainframe database, a log database that may produce programming for searching, monitoring, and analyzing machine-generated data via a web interface, but the disclosure is not limited thereto. In addition, the network resource database 312 and the immutable image repository 314 may store a plurality of applications and resources for performing endpoint device recovery.

In some embodiments, the endpoint recovery module 306 may be configured to receive a real-time feed of data from the plurality of client devices 308(1) … 308(n) and secondary sources via the communication network 310.

The endpoint recovery module 306 may be configured to: initiate a first boot cycle of an endpoint device; analyze, during the first boot cycle, system components of the endpoint device to determine an operational state of the endpoint device; detect, based on a result of the analyzing, a failure state of the endpoint device; initiate a second boot cycle of the endpoint device from a network resource that includes a recovery control plane that is accessible by the endpoint device; and execute, via the recovery control plane, a repaving of the endpoint device to a workable state. The repaving may include utilizing at least one from among image management and version management.

The plurality of client devices 308(1) … 308(n) are illustrated as being in communication with the endpoint recovery device 302. In this regard, the plurality of client devices 308(1) … 308(n) may be “clients” (e.g., customers) of the endpoint recovery device 302 and are described herein as such. Nevertheless, it is to be known and understood that the plurality of client devices 308(1) … 308(n) need not necessarily be “clients” of the endpoint recovery device 302, or any entity described in association therewith herein. Any additional or alternative relationship may exist between either or both plurality of client devices 308(1) … 308(n) and the endpoint recovery device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) … 308(n) may communicate with the endpoint recovery device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The endpoint recovery device 302 may be the same or similar to the endpoint recovery device 202 as described with respect to FIG. 2, including any features or combination of features described with respect thereto.

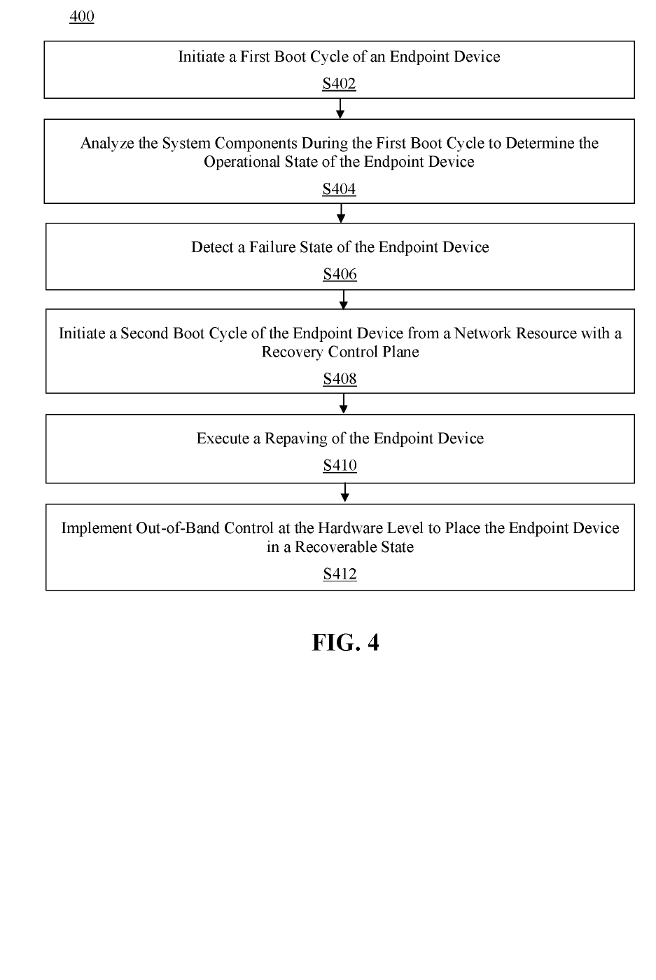

FIG. 4 illustrates a process 400 for performing a series of processes to execute a touchless recoverability strategy to remedy endpoint devices so that they are in an operable state, according to an embodiment.

In process 400 of FIG. 4, at step S402, the endpoint recovery device 302 may initiate a first boot cycle of the endpoint device. The endpoint device may be a computer, desktop, laptop, and/or any computing device. The boot cycle may relate to the start cycle or initiation sequence of the endpoint device.

At step S404, the endpoint recovery device 302 may analyze the system components of the endpoint device during the first boot cycle to determine the operational state of the endpoint device. The operational state of the endpoint device may include at least one from among a working operational state, a good state, an operable state, a failure state, an error state, an inoperable state, and/or an override state. The system components may include at least one from among a hardware, a hard drive, and an OS of the endpoint device. In an embodiment, the analyzing of the system components may include performing a series of performance checks on at least one from among a hardware of the endpoint device, a hard drive of the endpoint device, and an OS of the endpoint device, to determine a source of error in the endpoint device. For example, the endpoint recovery device 302 may insert itself into the boot process, observe any errors causing events within the boot process, and then determine actions to be taken in order to repair/recover the device. In some embodiments, the endpoint recovery device 302 may transmit the determined operational state of the endpoint device to a user via a telemetry system.

At step S406, the endpoint recovery device 302 may detect a failure state of the endpoint device based on a result of the analyzing. The failure state of the endpoint device may be blue screen event (i.e., the endpoint device has booted, but it is not in a usable state). The failure state may be an event where the endpoint device is not able to boot. In some embodiments, the endpoint device 302 may store the results of the analysis and the results from the detecting in the recovery control plane. The endpoint recovery device 302 may then compare the results of the analysis and the results of the detecting with historical endpoint error data stored in the recovery control plane to determine a solution for remedying the failure state of the endpoint device. For example, in the case of a blue screen event, in which the device boots to a non-usable state, the endpoint recovery device 302 may detect that the endpoint device in is in a failure state. The endpoint recovery device 302 may then be able to insert logic into the endpoint device for recovery.

At step S408, the endpoint recovery device 302 may initiate a second boot cycle of the endpoint device from a network resource having a recovery control plane. The initiating of the second boot cycle may be responsive to the detection of the failure state. The recovery control plane of the network resource may be accessible by the endpoint device. For example, after a failure to boot is detected, the endpoint recovery device 302 may alter the boot location of the endpoint device and have it boot from another location or from something other than itself. Specifically, in the alternate boot process, the endpoint recovery device 302 may direct the endpoint device to boot to a network resource instead of booting from the endpoint OS. The network resource may allow the endpoint device to get into the recovery control plane.

At step S410, the endpoint recovery device 302 may execute a repaving of the endpoint device. The repaving may be done via the recovery control plane. The repaving may get the endpoint device to perform in a workable/operable state. The repaving may utilize at least one from among image management and version management. In some embodiments, the executing of the repaving may include implementing an immutable image on the endpoint device. The immutable image may include both a software release and a patch release that were implemented on the endpoint device. For example, there may be a July release with x patches and y software, those releases may be bundled together to create the immutable image. The implementation of immutable images may enable drift management as well as version management of the endpoint device. In an embodiment, the immutable image may be selected from an immutable image repository (e.g., the immutable image repository 314). The immutable image selected may be the second most recent immutable image in the immutable image repository to ensure recoverability to a verified working state. In other words, the immutable image repository may go to the N-1 image of the repository to ensure certainty of recoverability. For example, the endpoint recovery device 302 may insert logic that directs the endpoint device to boot to some other payload to get to a known OS (e.g., WinPE) that allows the endpoint device to be repaved to a known workable state.

Then, at step S412, the endpoint recovery device 302 may implement out-of-band control within the hardware of the endpoint device to place the endpoint device in a recoverable state. The out-of-band control may use system-on-chip technology that interacts with the hardware of the endpoint device, whether it is in a bootable or a non-bootable state, in order to control certain operations of the endpoint device (e.g., power on, power off, move to some other state, etc.). The out-of-band control may incorporate the recovery control plane within the endpoint device in order to get the endpoint device to a recoverable state. For example, when out-of-band control is incorporated into the recovery control plane and the device is determined to be inoperable, the endpoint recovery device 302 may restart the whole recovery process over again. Thus, this out-of-band control can be enacted to start each process or step all over again, to get the endpoint device back in a recoverable state.

The endpoint recovery device 302 may incorporate physical assets, cloud control plane recovery, and logic to determine the operation state of an endpoint device and recover the endpoint device if it is in a detected bad state. The endpoint recovery device 302 may start with the proliferation of physical computing assets and then may insert a process that goes into the end point device’s boot cycle. In other words, the process of the endpoint recovery device 302 goes through a series of steps to check the hardware, then the hard drive, and then moves to the OS, in order to detect what may have happened previously that may be causing the endpoint device to be in an inoperable state. Thus, the endpoint recovery device 302 may have the ability to detect a bad state, boot to an alternate recovery environment, and then transmit instructions set down from the control plane to determine if the state is good, bad, or if someone is overriding the state because maintenance is required.

In an embodiment, the endpoint recovery device 302 may generate a telemetry stream in the boot sequence that provides a user details on why the device is inoperable. Additionally, with this telemetry stream, the endpoint device may be accessible as long as the endpoint device is connected to a network. The telemetry stream may also be paired with out-of-band management control that allows the endpoint device to be accessed and fixed remotely. Moreover, the endpoint recovery device 302 may also have a detection library that interprets the telemetry stream and couples the information or data from the telemetry stream with associated actions for self-heal/repair. For example, if the endpoint recovery device 302 identifies an “error A”. The endpoint recovery device 302 may utilize the detection library to determine the appropriate steps or actions for fixing “error A”, and then executes these steps using the out-of-band management control engine. Additionally, the endpoint recovery device 302 may incorporate a learning mechanism that analyzes the prior data, determines the issue with the endpoint device, and performs the necessary functions for fixing the endpoint device based on the analysis of the prior data. In an embodiment, the endpoint recovery device 302 may integrate cloud technology (e.g., CDN) to ensure that the necessary software, bits, recovery steps, etc. may be quickly deployed and transmitted to every endpoint device registered within the system. Thus, enabling device recovery in real-time or near real-time.

In some embodiments, the endpoint recovery device 302 may offer a one-size fits all approach for enterprise needs to encompass: device management, device repave, and out-of-band control. The endpoint recovery device 302 may also provide proactive monitoring for device outage and response. Additionally, the endpoint recovery device 302 may provide global scalability by utilizing a CDN with the ability to get large OS payloads from the “closest” point possible to the endpoint device and ensure that data is regionally distributed.

In an embodiment, the endpoint recovery device 302 may include an in-house orchestration engine that provides a detection rule engine and an administrative repave solution at scale. The endpoint recovery device 302 may also leverage CDN to diversify and minimize concentration Additionally, the endpoint recovery device 302 may certify and secure hardware (e.g., "system on chip") recovery capabilities to provide out-of-band control to non-recoverable endpoints. Moreover, the endpoint recovery device 302 may implement write-filter or differencing disk technology that will revert the operating system changes to a last known good state upon reboot.

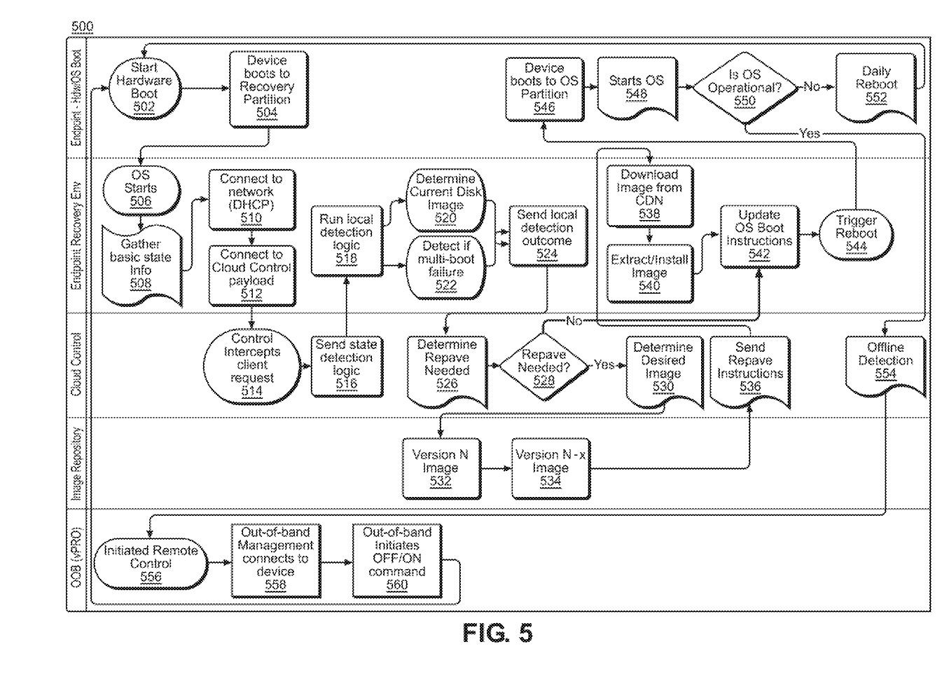

FIG. 5 illustrates a flow diagram of a process 500 for performing a series of processes to execute a touchless recoverability strategy to remedy endpoint devices so that they are in an operable state, according to an embodiment. Particularly, the flow diagram 500 illustrates an implementation of the process 400 from FIG. 4, according to an embodiment.

In process 500 of FIG. 5, at step 502, the endpoint recovery device 302 initiates or starts a boot cycle of the hardware of the endpoint device. At step 504, the endpoint device boots to a recovery partition or a second boot cycle that is located on a different system, location, or device from the endpoint device. At step 506, the OS of the recovery partition starts in an endpoint recovery environment of endpoint recovery device 302. At step 508, the endpoint recovery device 302 gathers basic state information of the endpoint device. At step 510, the endpoint device connects to a network. The network may be a Dynamic Host Configuration Protocol (DHCP), which may be a system that assigns Internet Protocol (IP) addresses to each network device on an organization's network. At step 512, the endpoint device is connected to a cloud control or recovery control plane of the endpoint recovery device 302.

Next, at step 514, the cloud control intercepts client requests of the endpoint device. At step 516, the cloud control sends state detection logic of the endpoint device to the endpoint recovery environment. At step 518, the endpoint recovery device 302 then runs local detection logic on the endpoint device. The local detection logic includes: step 520 where the endpoint recovery device 302 determines a current disk image; and step 522, where the endpoint recovery device 302 detects if there have been multiple boot sequence failures. At step 524, the endpoint recovery device 302 sends the results of the local detection logic to the cloud control.

Based on the results of the local detection logic, at step 526, the cloud control determines if repave is needed. At step 528, logic is entered to determine which path to proceed based on whether repave is determined to be necessary. If repave is needed, the process 500 proceeds to step 530 to determine a desired image. At step 532, the image repository is searched to identify the version N image (i.e., the most recent image). At step 534, the endpoint recovery device 302 then identifies and selects the N-x image (e.g., the second most recent image). Repave instructions may be based on the selected N-x image. At step 536, the endpoint recovery device 302 sends the repave instructions to the endpoint recovery environment. At step 538, the endpoint recovery device 302 downloads the N-x image from a CDN. Then, at step 540 the image is extracted and installed on the endpoint device.

Next, at step 542, the OS boot instructions are updated based on the downloaded image. Additionally, if, at step 526 and 528, it was determined that repave was not needed, the process 500 proceeds to step 542 and the OS boot instructions are updated based on the local detection logic results. At step 544, a reboot is triggered. At step 546, the endpoint device boots to the OS partition that is now located on the endpoint device. At step 548, the OS is started. At step 550, the endpoint recovery device 302 determines if the OS is operational. If the OS is determined not to be operational, then the process 500 proceeds to step 552 in which a daily reboot is performed and the process 500 starts over again at step 502. If the OS is operational, then the process 500 proceeds to step 554 for offline detection. At step 556, the endpoint recovery device 302 enables out-of-band management to initiate remote control. At step 558, the out-of-band management connects to the endpoint device. At step 560, the out-of-band management initiates an off/on command to the endpoint device. Then, the process 500 proceeds back to step 502.

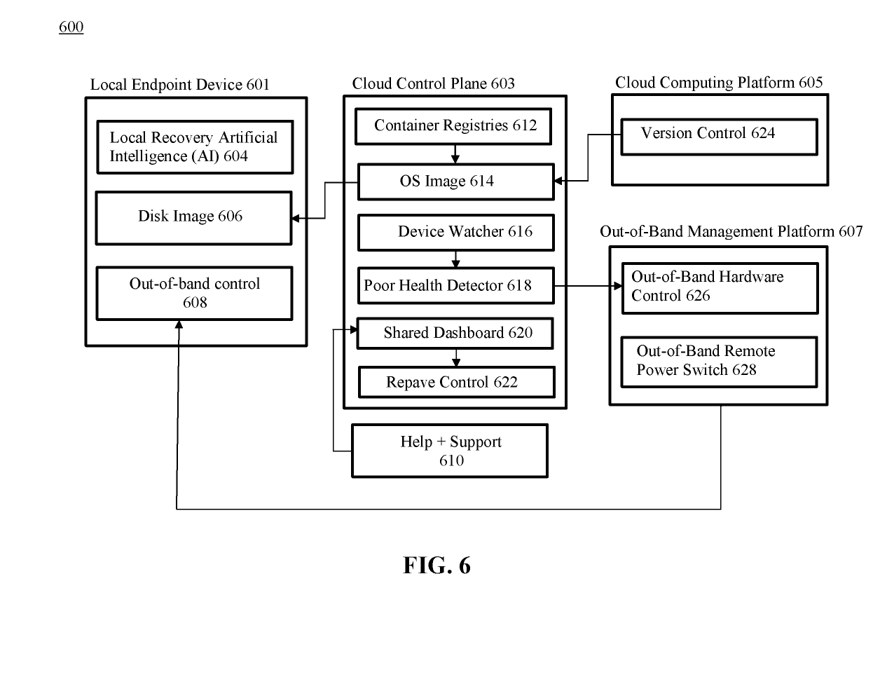

FIG. 6 illustrates a system diagram 600 for performing a series of processes to execute a touchless recoverability strategy to remedy endpoint devices so that they are in an operable state, according to an embodiment.

FIG. 6 shows a local endpoint device 601, a cloud control plane 603, a cloud computing platform 605, and an out-of-band management platform 607. The local endpoint device 601 includes a local recovery artificial intelligence (AI) module 604 that may provide data, suggestions, and/or mechanisms for recovering the device at the local level. The local endpoint device 601 also includes a disk image module 606 that allows the local endpoint device 601 to enter a recovery state based on an OS image 614 received from the cloud control plane 603. The local endpoint device 601 also includes an out-of-band control module 608 that enables out-of-band control from the out-of-band management platform 607.

The cloud control plane 603 includes container registries 612 that includes a plurality of OS and/or immutable images. The cloud control plane 603 selects an appropriate OS image and transmits this image to the disk image module 606, which may allow the local endpoint device 601 to enter a usable state. The cloud computing platform 605 includes a version control module 624 that may be used for selecting the appropriate OS image 614. The cloud control plane 603 also includes a device watcher 616 that is capable of analyzing the local endpoint device 601 and transmits the results to the poor health detector 618, of the cloud control plane 603, when an inoperable state is detected. The poor health detector transmits the results to the out-of-band hardware control module 626 of the out-of-band management platform 607. Moreover, the cloud control plane 603 includes a shared dashboard 620 that receives support information from a help and support module 610. The shared dashboard then uses the information to initiate the repave control module 622, which performs a repave operation of the local endpoint device 601.

The out-of-band management platform 607 includes the out-of-band hardware control module 626 that initiates out-of-band control of the local endpoint device 601, when an inoperable state is detected. The out-of-band management platform 607 also includes an out-of-band remote power switch 628 that enables control of the power of the local endpoint device 601. The out-of-band management platform 607 transmits signals to the out-of-band control module 608 to perform out-of-band control of the local endpoint device 601, in order to place it in an operable state.

Accordingly, with this technology, an optimized process for performing a series of processes to execute a touchless recoverability strategy to remedy endpoint devices so that they are in an operable state is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for performing endpoint device recovery, the method being implemented by at least one processor, the method comprising:
initiating, by the at least one processor, a first boot cycle of an endpoint device;
analyzing, by the at least one processor during the first boot cycle, system components of the endpoint device to determine an operational state of the endpoint device;
detecting, by the at least one processor and based on a result of the analyzing, a failure state of the endpoint device;
initiating, by the at least one processor, a second boot cycle of the endpoint device from a network resource, wherein the network resource includes a recovery control plane that is accessible by the endpoint device; and
executing, by the at least one processor via the recovery control plane, a repaving of the endpoint device to a workable state, wherein the repaving includes utilizing at least one from among image management and version management.

2. The method of claim 1, further comprising:
interacting, by the at least one processor via the recovery control plane, with a hardware component of the endpoint device to implement out-of-band control for incorporating the recovery control plane within the endpoint device to place the endpoint device in a recoverable state.

3. The method of claim 1, wherein the analyzing of the system components includes performing a series of performance checks on at least one from among a hardware of the endpoint device, a hard drive of the endpoint device, and an operating system of the endpoint device to determine a source of error in the endpoint device.

4. The method of claim 1, further comprising;
determining, by the at least one processor via the recovery control plane, whether an operating system of the endpoint device is in one from among an operable state, an inoperable state, and an override state.

5. The method of claim 1, wherein the executing of the repaving comprises implementing a first immutable image on the endpoint device, wherein the first immutable image includes a software release and a patch release.

6. The method of claim 5, wherein the first immutable image is selected from an immutable image repository, and wherein the first immutable image is a second most recent immutable image in the immutable image repository.

7. The method of claim 1, further comprising:
transmitting, by the at least one processor via a telemetry system, the determined operational state of the endpoint device to a user.

8. The method of claim 1, further comprising:
storing, by the at least one processor in the recovery control plane, a result of the analyzing and a result of the detecting; and
comparing, by the at least one processor, the result of the analyzing and the result of the detecting with historical endpoint error data stored in the recovery control plane to determine a solution for remedying the failure state of the endpoint device.

9. A computing apparatus for performing endpoint device recovery, the computing apparatus comprising:
a processor;
a memory; and
a communication interface coupled to each of the processor and the memory,
wherein the processor is configured to:
initiate a first boot cycle of an endpoint device;
analyze, during the first boot cycle, system components of the endpoint device to determine an operational state of the endpoint device;
detect, based on a result of the analyzing, a failure state of the endpoint device;
initiate a second boot cycle of the endpoint device from a network resource, wherein the network resource includes a recovery control plane that is accessible by the endpoint device; and
execute, via the recovery control plane, a repaving of the endpoint device to a workable state, wherein the repaving includes utilizing at least one from among image management and version management.

10. The computing apparatus of claim 9, wherein the processor is further configured to:
interact, via the recovery control plane, with a hardware component of the endpoint device to implement out-of-band control for incorporating the recovery control plane within the endpoint device to place the endpoint device in a recoverable state.

11. The computing apparatus of claim 9, wherein the analyzing of the system components includes performing a series of performance checks on at least one from among a hardware of the endpoint device, a hard drive of the endpoint device, and an operating system of the endpoint device to determine a source of error in the endpoint device.

12. The computing apparatus of claim 9, wherein the processor is further configured to:
determine, via the recovery control plane, whether an operating system of the endpoint device is in one from among an operable state, an inoperable state, and an override state.

13. The computing apparatus of claim 9, wherein the executing of the repaving comprises implementing a first immutable image on the endpoint device, wherein the first immutable image includes a software release and a patch release.

14. The computing apparatus of claim 13, wherein the first immutable image is selected from an immutable image repository, and wherein the first immutable image is a second most recent immutable image in the immutable image repository.

15. The computing apparatus of claim 9, wherein the processor is further configured to:
transmit, via a telemetry system, the determined operational state of the endpoint device to a user.

16. The computing apparatus of claim 9, wherein the processor is further configured to:
store, in the recovery control plane, a result of the analyzing and a result of the detecting; and
compare the result of the analyzing and the result of the detecting with historical endpoint error data stored in the recovery control plane to determine a solution for remedying the failure state of the endpoint device.

17. A non-transitory computer readable storage medium storing instructions for triggering application workflows, the storage medium comprising executable code which, when executed by a processor, causes the processor to:
initiate a first boot cycle of an endpoint device;
analyze, during the first boot cycle, system components of the endpoint device to determine an operational state of the endpoint device;
detect, based on a result of the analyzing, a failure state of the endpoint device;
initiate a second boot cycle of the endpoint device from a network resource, wherein the network resource includes a recovery control plane that is accessible by the endpoint device; and
execute, via the recovery control plane, a repaving of the endpoint device to a workable state, wherein the repaving includes utilizing at least one from among image management and version management.

18. The storage medium of claim 17, wherein the executable code further causes the processor to:
interact, via the recovery control plane, with a hardware component of the endpoint device to implement out-of-band control for incorporating the recovery control plane within the endpoint device to place the endpoint device in a recoverable state.

19. The storage medium of claim 17, wherein the analyzing of the system components includes performing a series of performance checks on at least one from among a hardware of the endpoint device, a hard drive of the endpoint device, and an operating system of the endpoint device to determine a source of error in the endpoint device.

20. The storage medium of claim 17, wherein the executable code further causes the processor to:
determine, via the recovery control plane, whether an operating system of the endpoint device is in one from among an operable state, an inoperable state, and an override state.
